(19) United States
(12) Patent Application Publication
(10) Pub. No.: US 2007/0298856 A1
(43) Pub. Date: Dec. 27, 2007

(54) Wagering Game with Episodic-Game Feature for Payoffs

(76) Inventors: Jason C. Gilmore, Scottsdale, AZ (US); Bradley A. Rose, Chicago, IL (US)

Correspondence Address: NIXON PEABODY LLP, 161 N. CLARK STREET, 48TH FLOOR, CHICAGO, IL, 60601-3213, US

(21) Appl. No.: 11/629,399

(22) PCT Filed: Jul. 1, 2005
(86) PCT No.: PCT/US05/23779

§ 371 Date: Aug. 9, 2007

Related U.S. Application Data
(60) Provisional application No. 60/586,064, filed on Jul. 7, 2004.

(51) Int. Cl. G06F 17/00

(52) U.S. Cl. 463/16

(57) ABSTRACT

A method for conducting a wagering game includes receiving a wager input from a player for playing a wagering game during a gaming session. The wagering game has a game-play progression that includes a plurality of game episodes. At least one randomly-selected outcome is selected from a plurality of outcomes in response to receiving the wager input. In response to a predetermined game-play condition, a first game episode is completed and a status of the game-play progression is saved. In response to playing a subsequent gaming session of the wagering game, game-play is continued in a second game episode from the saved status of the game-play progression.

### FIELD OF THE INVENTION

The present invention relates generally to gaming terminals for playing a wagering game and, more particularly, to a gaming terminal for playing a plurality of game episodes in multiple gaming sessions.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by enhancing the entertainment value and excitement associated with the game.

One concept that has been successfully employed to enhance the entertainment value of a game is that of a “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Another concept that has been employed is the use of a progressive jackpot. In the gaming industry, a “progressive” involves collecting coin-in data from participating gaming device(s) (e.g., slot machines), contributing a percentage of that coin-in data to a jackpot amount, and awarding that jackpot amount to a player upon the occurrence of a certain jackpot-won event. The percentage of the coin-in is determined prior to any result being achieved and is independent of any result. A jackpot-won event typically occurs when a “progressive winning position” is achieved at a participating gaming device. If the gaming device is a slot machine, a progressive winning position may, for example, correspond to alignment of progressive jackpot reel symbols along a certain payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement.

In current basic games, bonus games, and progressive games, the player is provided with little incentive to return the game at a later time. Once the player chooses to stop playing the game in that round, the player is immediately awarded any credits that are remaining and also loses assets that have been accumulated, but not yet awarded. For example, in some games, the bonus game consists of the player collecting assets and when a certain number or combination of assets is accumulated, the player wins an award. However, should the player choose to leave the game prior to winning the award, the player loses all of the assets accumulated. This can cause player frustration and does not provide the player with any incentive to return to the game.

Such a system also encourages “vulturing,” in which the “vulturing” player waits for a person who is close to winning an award to leave the gaming machine prior to the winning of the award. The “vulturing” player then begins to play the machine, and may quickly win the award without investing much time into the game. This is also frustrating for other players.

Thus, there is a need to allow a player to accumulate assets on gaming terminals and to have those assets restored to them should the player return to the game at a later time. This way, should a player choose to leave a game, anything the player has accumulated during the game goes with them and is restored at a later time when the player returns to the game. This alleviates the player frustration at losing assets that they have accumulated and also provides the player an incentive to return to the game at a later date.

### SUMMARY OF THE INVENTION

A method for conducting a wagering game includes receiving a wager input from a player for playing a wagering game during a gaming session. The wagering game has a game-play progression that includes a plurality of game episodes. At least one randomly-selected outcome is selected from a plurality of outcomes in response to receiving the wager input. In response to a predetermined game-play condition, a first game episode is completed and a status of the game-play progression is saved. In response to playing a subsequent gaming session of the wagering game, game-play is continued in a second game episode from the saved status of the game-play progression.

In another aspect of the present invention, a method for conducting a wagering game includes receiving a wager input from a player for playing a wagering game having a plurality of episodes. At least one randomly-selected outcome of a plurality of outcomes is selected in response to receiving the wager input. In response to completing a first one of the plurality of episodes in an initial gaming session, a second one of the plurality of episodes is triggered. The second one of the plurality of episodes is played in a subsequent gaming session.

In an alternative aspect of the present invention, a gaming terminal for playing a wagering game includes a display for displaying at least one randomly-selected outcome of a plurality of outcomes in response to accepting a wager for playing a wagering game. The wagering game has a game-play progression that includes a plurality of game episodes. The gaming terminal further includes a controller that is coupled to the display and that is operative to save a status of the game-play progression when a first game episode of the plurality of game episodes has been completed. The first game episode is completed in response to an occurrence of a predetermined game-play condition during a gaming session of the wagering game. The controller is further operative to continue game-play from the saved status of the game-play progression in a second game episode of the plurality of game episodes. The second game episode occurs in a subsequent gaming session of the wagering game.

In an alternative aspect of the present invention, a method for conducting multiple wagering games includes receiving a first wager input for playing a first wagering game during a gaming session. The first wagering game has a first game episode. At least one randomly-selected outcome is selected from a plurality of outcomes in response to receiving the first wager input. In response to completing the first game episode, a status of a game-play progression is saved. A second wager input is received for playing a second wagering game during a subsequent gaming session. The second wagering game has a second game episode. Game-play is continued in the second game episode from the saved status of the game-play progression.

The above summary of the present invention is not intended to represent each embodiment, or every aspect, of the present invention. Additional features and benefits of the present invention are apparent from the detailed description, figures, and claims set forth below.

### BRIEF DESCRIPTION OF THE FIGURES

FIG. 1 is a perspective view of a video gaming terminal according to one embodiment of the present invention.

FIG. 2 is a block diagram of the gaming terminal of FIG. 1.

FIG. 3 is a flowchart of an exemplary method of conducting a wagering game using the gaming terminal of FIG. 1

FIG. 4a represents an exemplary screen displayed on a secondary display of the gaming terminal of FIG. 1 before a first selection of a bonus game.

FIG. 4b represents an exemplary screen displayed on a main display of the gaming terminal of FIG. 1 before a first selection of a bonus game episode.

FIG. 5a represents the exemplary screen of FIG. 4a before a second selection of the bonus game episode.

FIG. 5b represents the exemplary screen of FIG. 4b before a second selection of the bonus game episode.

FIG. 6a represents the exemplary screen of FIG. 4a before a third selection of the bonus game episode.

FIG. 6b represents the exemplary screen of FIG. 4b before a third selection of the bonus game episode.

FIG. 7a represents the exemplary screen of FIG. 4a before a fourth selection of the bonus game episode.

FIG. 7b represents the exemplary screen of FIG. 4b before a fourth selection of the bonus game episode.

FIG. 8a represents the exemplary screen of FIG. 4a after a fourth selection of the bonus game episode.

FIG. 8b represents the exemplary screen of FIG. 4b after a fourth selection of the bonus game episode.

FIG. 9a represents the exemplary screen of FIG. 4a after advancing to a next level of the bonus game episode.

FIG. 9b represents the exemplary screen of FIG. 4b after advancing to a next level of the bonus game episode.

FIG. 10 represents an exemplary screen displayed on a main display of the gaining terminal of FIG. 1 after triggering a new bonus game episode.

FIG. 11a represents an exemplary screen displayed on a main display of the gaming terminal of FIG. 1 after a first selection of the bonus game episode of FIG. 10

FIG. 11b represents an exemplary screen displayed on a secondary display of the gaming terminal of FIG. 1 after a first selection of the bonus game episode of FIG. 10.

FIG. 12 represents a game episode schematic of a wagering game.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENTS

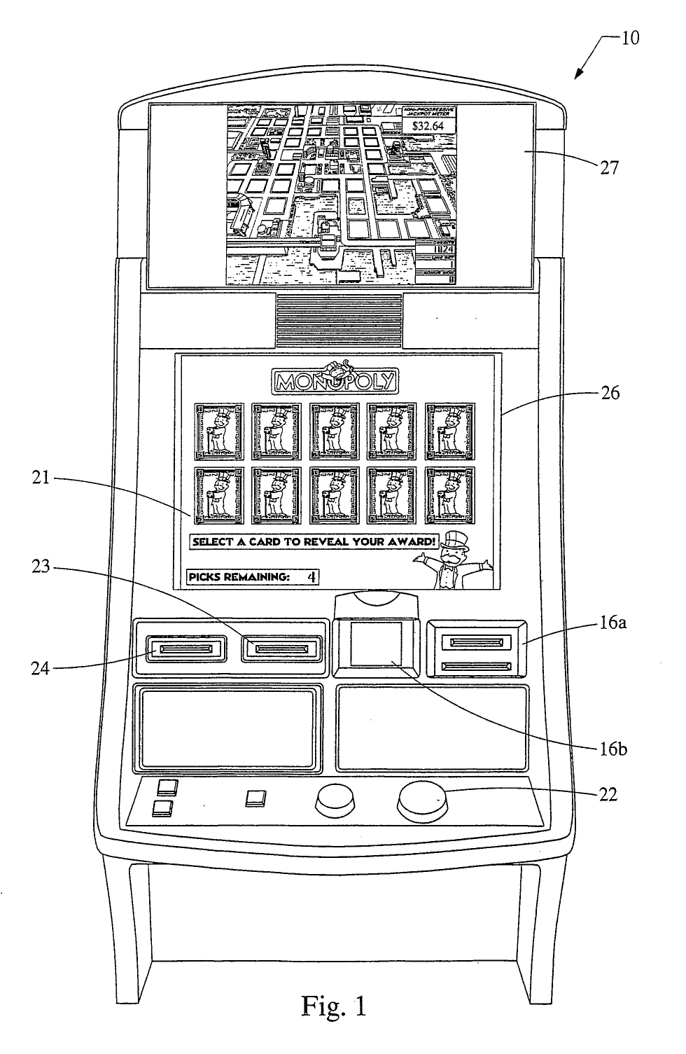

FIG. 1 shows a perspective view of a typical gaming terminal 10 used by gaming establishments, such as casinos. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play video slots or a video casino game, such as blackjack, slots, keno, poker, etc.

As shown, the gaming terminal 10 includes input devices, such as a wager acceptor 16 (shown as a card wager acceptor 16a and a cash wager acceptor 16b), a touch screen 21, a push-button panel 22, and an information reader 24. For outputs, the gaming terminal 10 includes a payout mechanism 23, a main display 26 for displaying information about the basic wagering game, and a secondary display 27 that may display an electronic version of a pay table, and/or also possibly game-related information or other entertainment features. While these typical components found in the gaming terminal 10 are described below, it should be understood that numerous other elements may exist and may be used in any number of combinations to create various forms of a gaming terminal.

The wager acceptor 16 may be provided in many forms, individually or in combination. The cash wager acceptor 16a may include a coin slot acceptor or a note acceptor to input value to the gaming terminal 10. The card wager acceptor 16b may include a card-reading device for reading a card that has a recorded monetary value with which it is associated. The card wager acceptor 16b may also receive a card that authorizes access to a central account, which can transfer money to the gaming terminal 10.

Also included is the payout mechanism 23, which performs the reverse functions of the wager acceptor. For example, the payout mechanism 23 may include a coin dispenser or a note dispenser to output value from gaming terminal 10. Also, the payout mechanism 23 may also be adapted to receive a card that authorizes the gaming terminal to transfer credits from the gaming terminal 10 to a central account.

The push button panel 22 is typically offered, in addition to the touch screen 21, to provide players with an option on how to make their game selections. Alternatively, the push button panel 22 provides inputs for one aspect of operating the game, while the touch screen 21 allows for inputs needed for another aspect of operating the game.

The outcome of the basic wagering game is displayed to the player on the main display 26. The main display 26 may take the form of a cathode ray tube (CRT), a high resolution LCD, a plasma display, LED, or any other type of video display suitable for use in the gaming terminal 10. As shown, the main display 26 includes the touch screen 21 overlaying the entire monitor (or a portion thereof) to allow players to make game-related selections. Alternatively, the gaming terminal 10 may have a number of mechanical reels to display the game outcome, as well.

In some embodiments, the information reader 24 is a card reader that allows for identification of a player by reading a card with information indicating his or her true identity. Currently, identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the player-identification card reader 24, which allows the casino's computers to register that player's wagering at the gaming terminal 10. The information reader 24 may also include a keypad (not shown) for entering a personal identification number (PIN). The gaming terminal 10 may require that the player enter their PIN prior to obtaining information. The gaming terminal 10 may use the secondary display 27 for providing the player with information about his or her account or other player-specific information. Also, in some embodiments, the information reader 24 may be used to restore assets that the player achieved during a previous game session and had saved.

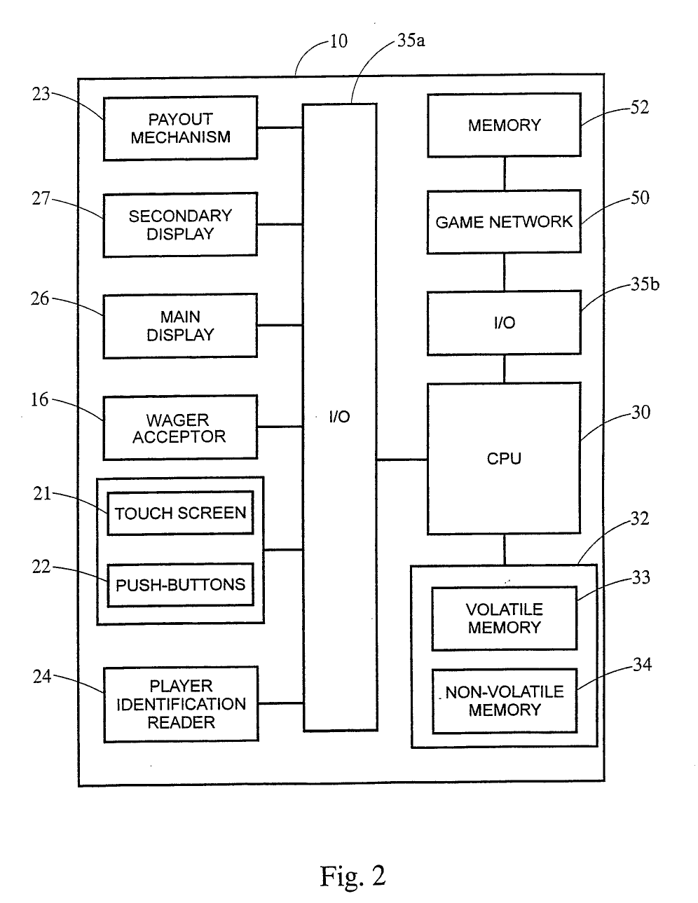

As shown in FIG. 2, the various components of the gaming terminal 10 are controlled by a central processing unit (CPU) 30 (such as a microprocessor or microcontroller). To provide the gaming functions, the CPU 30 executes a game program that allows for the randomly selected outcome. The CPU 30 is also coupled to or includes a local memory 32. The local memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the local memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral components of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

In some embodiments, the CPU 30 may not be inside the gaming terminal 10. Instead, the CPU 30 may be part of a game network 50 (FIG. 2) and may be used to control numerous gaming terminals 10. In these embodiments, the CPU 30 will run the basic games for each of the gaming terminals 10, and may also be used to link the gaming terminals 10 together. The game network 50 can include progressive jackpots that are contributed to by all or some of the gaming terminals 10 in the network (e.g., terminal-level jackpots that only each terminal 10 contributes to, bank-level jackpots that are contributed to by all of the terminals 10 in a particular bank, and wide-area jackpots that are contributed to by a larger number of terminals 10, such as multiple banks). Alternatively, the game network 50 can allow the player to retrieve assets obtained while playing one terminal 10 at a different gaming terminal that is also part of the game network. Assets may be any number of things, including, but not limited to, monetary or non-monetary awards, features that a player builds up in a bonus or progressive game to win awards, etc.

In some embodiments, the CPU 30 is also used with the information reader 24 to restore saved assets. For example, in one embodiment, the information reader 24 is adapted to receive and distribute tickets. The tickets each include a unique identifier. The unique identifier links the ticket to a file contained within the local memory 32 or a system memory 52 located in the game network 50. The file includes the assets that are being stored from a previous game. Monetary awards include game credits or money, while the non-monetary awards can be free plays (e.g., free spins), multipliers, or access to bonus and/or progressive games.

When a player inserts a ticket into the information reader 24, the CPU 30 obtains the unique identifier and causes the appropriate memory 32, 52 to be searched, and the file containing the unique identifier matching the identifier on the ticket is retrieved. Any assets or other information contained in this file are then transmitted to the gaming terminal 10, and the player regains any assets that were saved during a previous game. This allows the player to keep assets even after a particular gaming session ends, which increases player commitment to a game and decreases vulturing.

In other embodiments, the information reader 24 may include a card reader, and the unique identifier provided at the gaming terminal 10 may be stored on a personal identification card, such as one described above. Or, the gaming terminal 10 includes a radio frequency identification device (RFID) transceiver or receiver so that an RFID transponder held by the player can be used to provide the unique identifier of the player at the gaming terminal 10 without the need to insert a card into the gaming terminal 10. RFID components can be those available from Pacific Northwest National Laboratory (under the United States Department of Energy) of Richland, Wash.

In other embodiments, the information reader 24 may include a biometric reader, such as a finger, hand, or retina scanner, and the unique identifier may be the scanned biometric information. Additional information regarding biometric scanning, such as fingerprint scanning or hand geometry scanning, is available from International Biometric Group LLC of New York, N.Y. Other biometric identification techniques can be used as well for providing a unique identifier of the player. For example, a microphone can be used in a biometric identification device on the gaming terminal so that the player can be recognized using a voice recognition system.

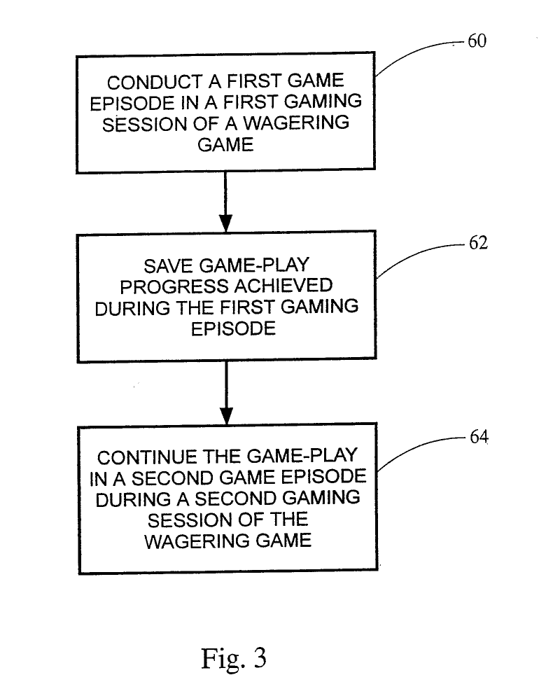

In summary, there are many techniques in which to provide a unique identifier for the player so that the assets accumulated by the player during one wagering session can be stored in either the system or local memory 52, 32, thereby allowing the player to subsequently access those assets at the same gaming terminal 10 or a different gaming terminal within the network 50. As described below with reference to FIGS. 3 to 7b, various assets related to the wagering game features and formats can be stored after one gaming session and used in a subsequent gaming session(s) to enhance the gaming experience for the player.

In general, episodic game play can provide a fun experience, loyalty, and replay-ability when a player explores episodes of a wagering game. Generally, a game episode can be described as a distinct game-play portion of a wagering game that begins when a start-episode event is triggered and ends when an end-episode condition is reached. The game episode is part of a game-play progression that includes a plurality of game episodes. The wagering game has a plurality of episodes, wherein an end of an episode generally triggers the beginning of another episode.

The start-episode event can be any game-play event. For example, a game episode can be triggered when a wager is submitted or when a game-play selection is made. An exemplary game-play selection is a selection of a winning combination. The end-episode condition can be any event that is related to the game-play of the wagering game. The game episode can end when a gaming session is terminated or when a game-play selection is made. For example, the game episode can end when a player cashes-out any awarded credits, i.e., terminates the gaming session, or when selecting a predetermined number of consecutive losing combinations. Additional examples of more specific triggering events and end-episode conditions will be described below with respect to alternative embodiments of the present invention.

Referring now to FIG. 3, a flowchart of an episodic wagering game will be described. At step 60 the player conducts a first game episode in a first gaming session of the wagering game. The first game episode begins when a player submits a wager and begins the first gaming session. At step 62 the first episode ends, and game-play progress that was achieved during the first game episode is saved. Optionally, the first gaming session of the wagering game is terminated at the end of the first game episode. At step 64 a second game episode is conducted in a second gaming session of the wagering game. The second game episode continues the game-play of the wagering game from the point where the first episode ended. Alternatively, the second game episode is conducted during the first gaming session of the wagering game.

To further explain the episodic wagering game of FIG. 3, an example will be described below. A player walks to a gaming terminal and submits a wager for playing a wagering game. The wager submission triggers the start of an episode of the wagering game. The player continues playing for several hours. After a while, the player decides to cash-out all the awarded winnings. The credit-meter is reduced to zero, signaling the end of the gaming session, and any progress that the player has achieved during the wagering game is saved on a player-tracking card. In this example, the saving of the game-play signals the end of the episode of the wagering game.

At a later time, the player returns to the gaming terminal and begins a new gaming episode and a new gaming session. The player inserts the player-tracking card in the gaming terminal and the game-play is restored to the point where the previous game episode had ended. Thus, the player begins a new game episode of the wagering game which continues the game-play from the previous game episode of the wagering game. The benefit to the player is that the player does not have to start the game-play from the beginning. The new gaming session begins when the player, upon his return to the gaming terminal, submits a wager for continuing the game-play from the previous gaming session. Although in the above example each of the game episodes begins and ends at the same time as the respective gaming session, in other embodiments a plurality of game episodes can be played during a single gaming session.

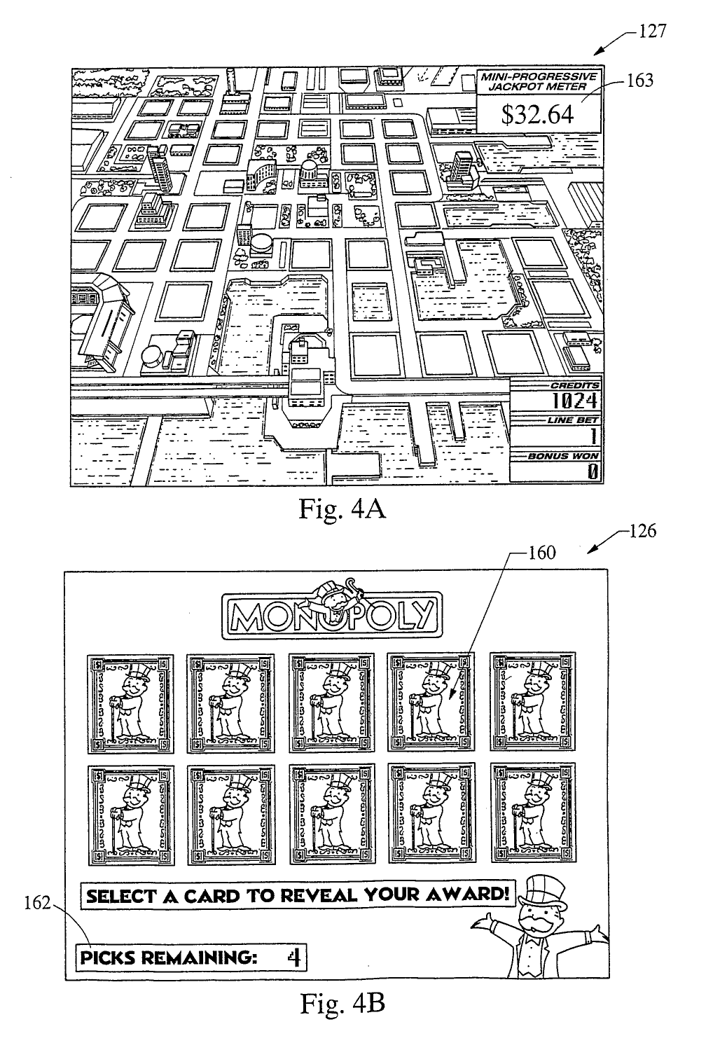

Referring to FIGS. 4a-11b, a method of episodic game-play for playing a linear bonus game will be described. The bonus game is based on the popular game of “Monopoly™,” and is triggered when a predetermined condition is met. For purposes of this example, it is assumed that the predetermined condition has been met. In FIG. 4a a monopoly board is shown in a secondary display 127, wherein potential locations for building a monopoly are displayed. A main display 126, shown in FIG. 4b, displays a plurality of cards 160 and prompts a player to select a card 160. A pick menu 162 indicates how many picks, or selections, are left in the bonus game. The player is awarded four picks when the bonus game is triggered. In addition, a mini-progressive jackpot meter 163 is displayed in the secondary display 127.

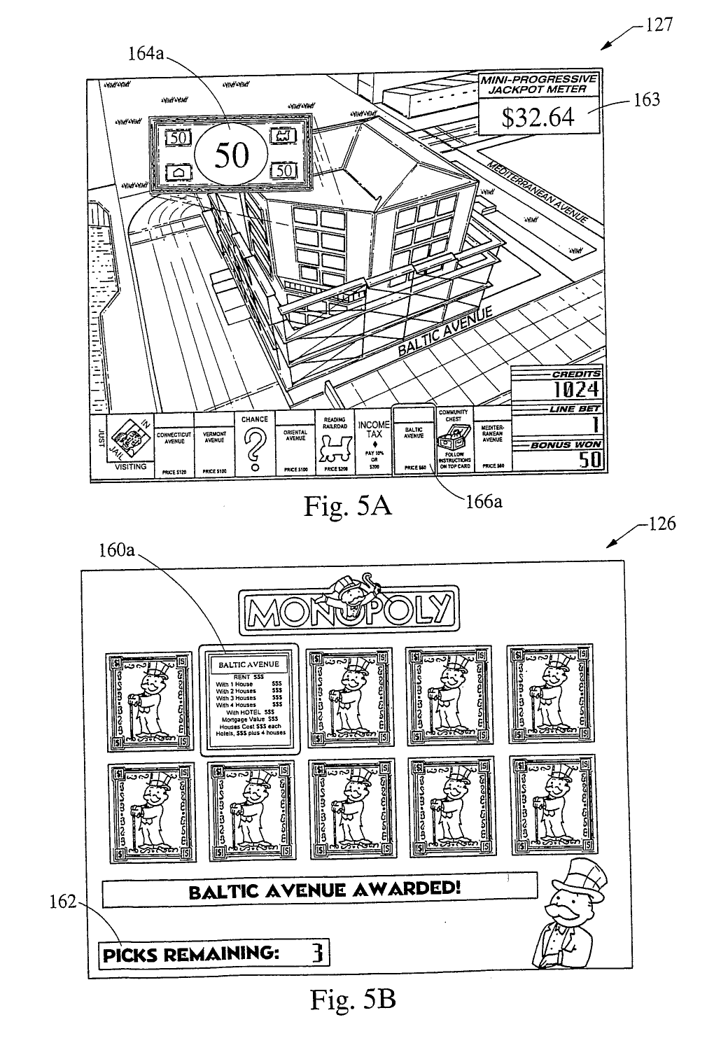

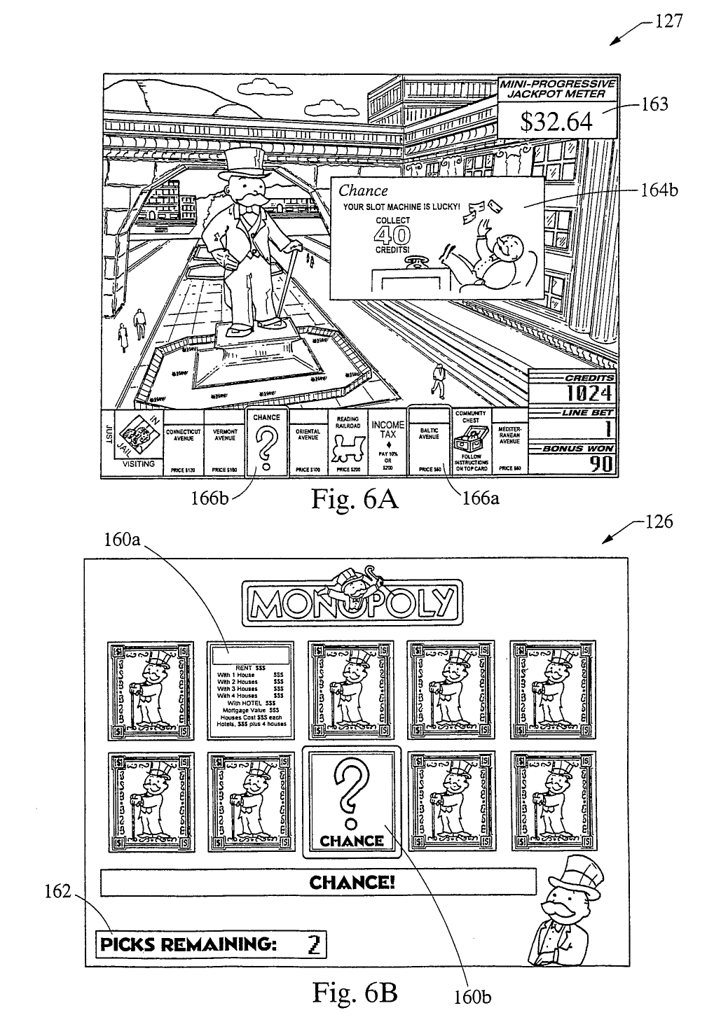

In FIGS. 5a and 5b the player has selected a card 160a, which reveals a property on “Baltic Avenue.” After the card 160a is revealed, a credit value 164a of fifty credits is awarded on the secondary display 127 and a corresponding section 166a of the monopoly board lights up to show the awarded property. The pick menu 162 indicates that three picks are remaining. Then, in FIGS. 6a and 6b, the player has selected another card 160b, which is a “Chance” card, and a credit value 164b of forty credits is awarded on the secondary display 127. A corresponding section 166b lights up on the monopoly board. The player must successfully receive a monopoly, i.e., reveal all the property sections of a kind, to advance to a next level of the game. As indicated, the player has two more picks remaining in this bonus round.

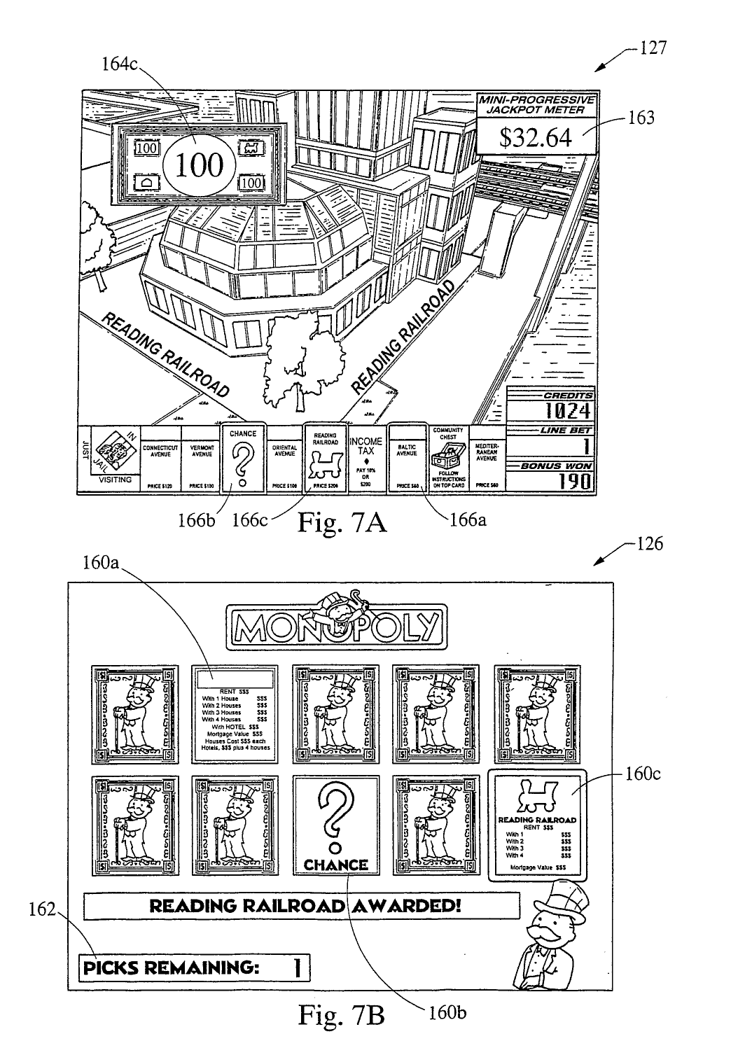

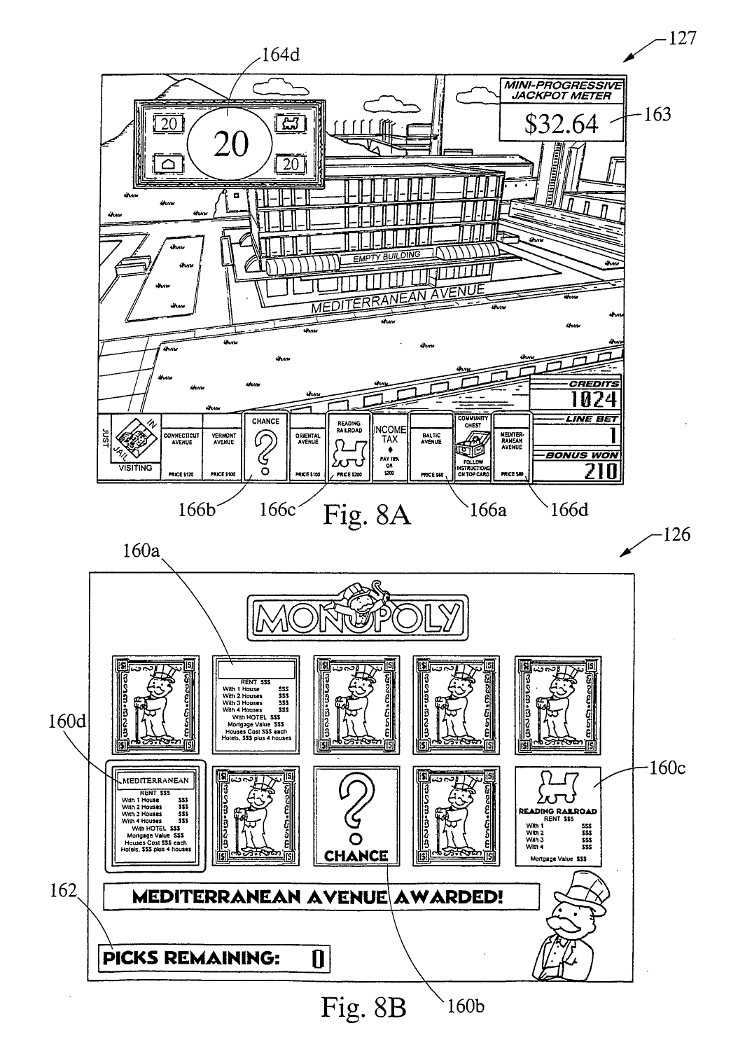

In FIGS. 7a and 7b the player has selected another card 160c, which reveals a “Reading Railroad” card. The player is awarded a credit value 164c of one hundred credits and a corresponding section 166c lights up to show the awarded property on the monopoly board. One pick remains in the bonus round. After selecting a last card 160d, as shown in FIGS. 8a and 8b, the property titled “Mediterranean Avenue” is revealed. A credit value 164d of twenty credits is awarded and a corresponding section 166d lights up on the monopoly board.

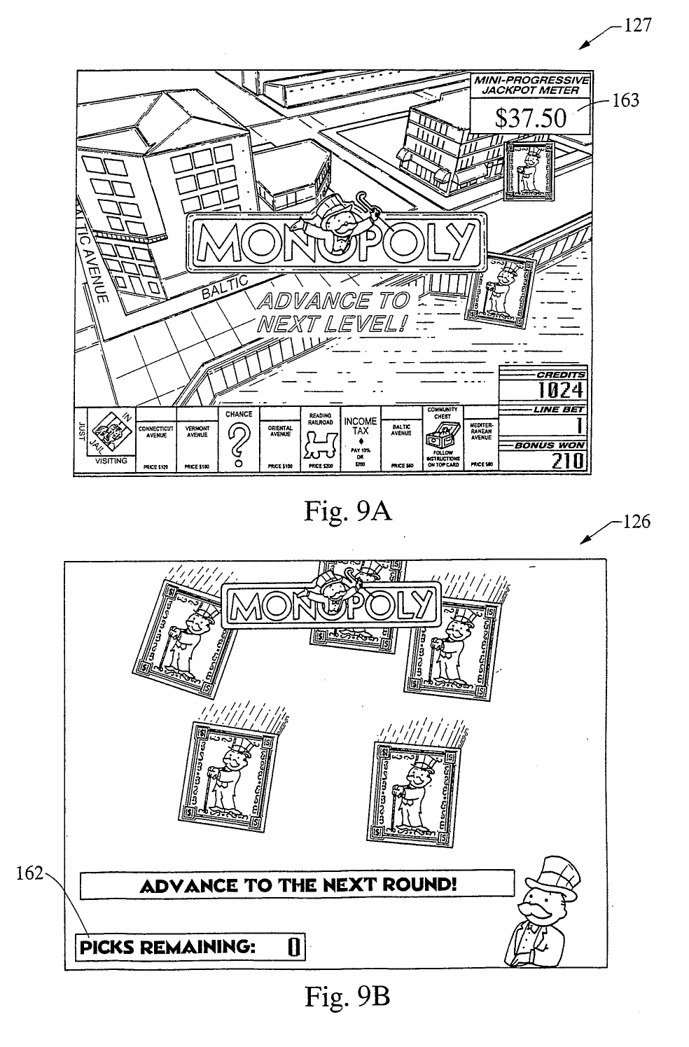

Referring to FIGS. 9a and 9b, the secondary display 127 shows that the player has successfully completed a monopoly and that the player has advanced to the next level. The selection of the “Baltic Avenue” and “Mediterranean Avenue” properties has revealed a monopoly. The value associated with the six unselected cards is added to the mini-progressive jackpot meter 163, which changes in value from $32.64 to $37.50. In this method of episodic game-play the bonus round, or episode, ends at this point and the player's level is saved on a player-tracking card.

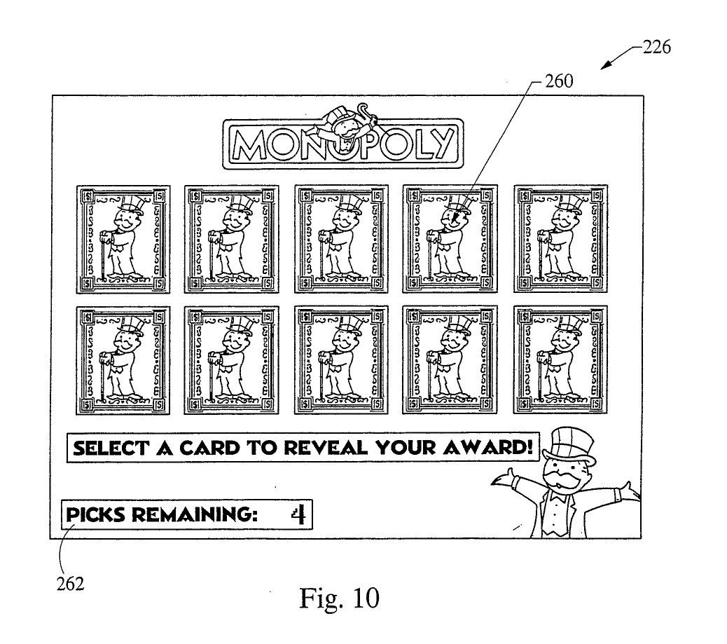

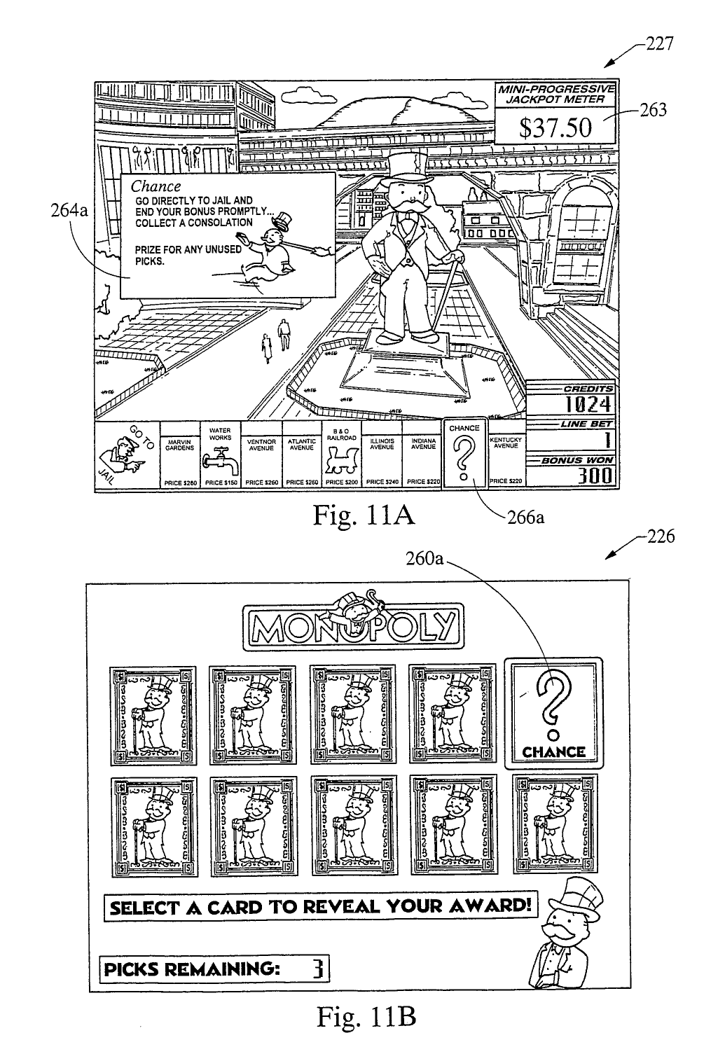

Referring to FIG. 10, a new bonus screen is displayed in a main display 226 when the bonus game is triggered again. A plurality of cards 260 are displayed on the main display 226 and a pick menu 262 indicates the number of selections remaining for the bonus episode. The game-play starts at an advanced level, which follows the level that the player had previously completed, by restoring information from the player-tracking card. Thus, as shown in FIGS. 11a and 11b, a new section of the monopoly board is displayed in a secondary display 227. Game-play in this episode is similar to the game-play in the previous episode. A mini-progressive jackpot meter 263 displays an amount of $37.50, which corresponds to the amount of the jackpot meter 163 when the previous bonus episode had ended. The player selects a card 260a that reveals a “Chance” card, which is highlighted in a corresponding section 266a on the monopoly board. The award 264a, or punishment, is that the player is sent “to jail,” which ends the bonus episode. The information associated with the game-play progress is saved on the player-tracking card, and when the bonus game is triggered again the player starts from the original level. Alternatively, the player can start at the advanced level.

Many variations can be applied to the above-described method of playing a bonus game. The completion of a level, which can signal the end the game episode, can be triggered by any predetermined condition of the game-play. For example, a level can be complete when a single card has been selected. Thus, every time the player has selected a card, the player is awarded the corresponding award and then the episode ends. The subsequent episode begins with the player selecting another card.

In an alternative embodiment of the current invention, the player can use a different gaming terminal for each game episode. Thus, even if the player changes casinos the information stored on the player-tracking card can be used in different gaming terminals. Alternatively, the player can use a single gaming terminal for playing different wagering games. For example, the player can play an episode of “Monopoly™” on a gaming terminal, and then, on the same gaming terminal, the player can play an episode of “Tic-Tac-Toe.” Optionally, a “Tic-Tac-Toe” episode can be triggered by the player having successfully completed an episode of the “Monopoly™” game, or vice versa.

In another alternative embodiment, other type of game-play progression can be used to provide an episodic game-play experience. The player can play a “Road Trip Monopoly” where the player can selected different regions of the United States, or other country, earning his or her way from board to board. For example, after winning a monopoly game based on New York City, the player advances, in subsequent episodes, to Chicago. In other examples, the player can advance in different game episodes, from one film to another film, or from one story to another story. If the game is related to a fishing contest, the player can advance, for example, from one lake to another lake, from one fishing contest to another fishing contest, and from one type of fish to a different type of fish. In a party theme game, the player can advance from one party to another party, from one small party to a bigger party, from a children party to an adult party, from one section of a party to a VIP (very important person) section of a party.

A gaming theme associated with a game episode of the wagering game can change based on the particular gaming terminal on which the wagering game is being conducted. Thus, the gaming theme of a game episode can be independent or dependent on a particular gaming terminal.

Another method of episodic game-play is a “Choose Your Own Adventure” method. The premise of this method is to include many branches, or paths, that a player can take to ultimately reach a final destination of a bonus round on a gaming terminal. The method can take place within one bonus round, or episode, or can be spread out to many bonus rounds by recording the progress of the game-play when a level is completed. Alternatively, the method can take place within a basic wagering game.

When the player reaches decision points in the bonus game, the choice that the player makes sends the player along a path that may differ from a typical linear bonus game. For example, the player can make a choice by selecting an item on a touch screen. Outcomes may be positive outcomes, such as credit awards, free spins, or physical prizes, or negative outcomes, such as ending the player's bonus. The paths of the bonus game may intersect, cross, or not intersect at all. Shortcuts may also be included in the bonus game to allow the player to jump ahead to another level. An illustration of this method is described below.

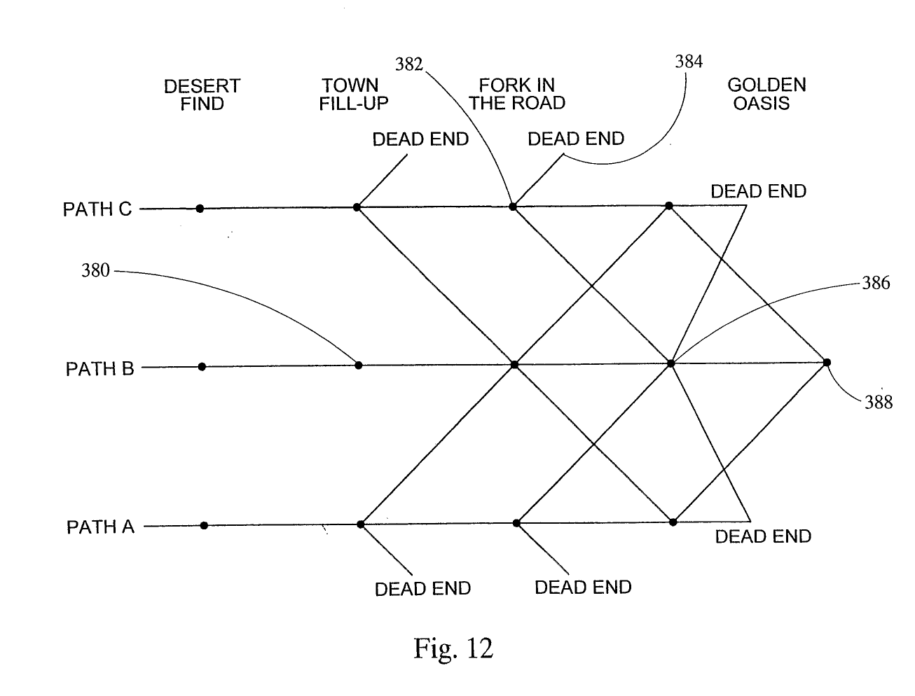

Referring to FIG. 12, three initial paths are provided to the player (Path A, Path B, and Path C). The player begins a journey through a desert, with the goal being to reach a “Golden Oasis.” At each intersection an event occurs and the player then follows a new path. Some choices lead to dead ends, other choices lead to other paths, and ultimately to the “Golden Oasis.”

For example, after triggering the bonus game the player is allowed to make to make three selections per game episode, unless a dead end is reached. The player makes a first selection by selecting Path B, which takes the player to a “Town Fill-up” event 380. Here, the player makes another selection and goes to event 382, which is a “Fork In the Road.”. The player then select event 384 which is a dead end. Thus, the game episode ends here. When the bonus game is triggered again, in the same or a different gaming session, the player begins the adventure at event 382. Aware that event 384 is a dead end, the player logically makes event 386, “Final Find, the first selection. The player's next selection is to go to event 388, the “Golden Oasis.” Having found the “Golden Oasis,” the bonus game in this example ends within two game episodes.

Many variations can be applied to the “Golden Oasis” method of playing a bonus game. For example, after reaching the “Golden Oasis” a change in appearance can be provided when the bonus game is triggered again. The change in appearance can give the player a different playing experience, even if the same game is being played. In a different variation, a game episode ends when the player has reached one of any of the “Town Fill-up” event, the “Fork in the Road” event, the “Final Find” event, and the “Golden Oasis” event.

Another method of episodic game-play is a “Character Adventure” method. When a player enters a basic wagering game or a bonus game on a gaming terminal, the player can select from a variety of characters to participate in the game. Each character has a separate set of events associated with it. For example, if the player has a choice between an Ogre, a Knight, and a Pauper in a bonus game, the Ogre would entitle the player to play bonus games from a forest, the Knight would entitle the player to play bonus games in a Kingdom, and the Pauper would entitle the player to play bonus games from a Countryside. The events may be common among all three characters and just look visually different, or the events may be entirely different from one another.

An alternative method of episodic game-play is an “Unlocking Events” method. When a player enters a game episode of a basic wagering game or a bonus wagering game, an item is selected that unlocks a new path or shortcut for the game. For example, the player can select an item that removes an amount of reel symbols. In turn, the removal of the symbols gives the player a mathematical advantage during the game. An unlocking event may also reveal a new bonus game that cannot be attained by normal game-play. The unlocked event can be represented visually by showing a celebration, as the player may not know that the event has been unlocked. Alternatively, a locked event symbol can be always shown on a display, such as having a padlock overlying it, until the unlocking event occurs. When the locked event has been unlocked, the locked event symbol can be replaced with another symbol, such as having the padlock removed. Optionally, events that have already been won can be locked out so that the player can focus his or her attention to remaining events that have not been unlocked. Further, the player can earn tickets on a reel play, wherein a different number of tickets can be redeemed for different bonus episodes.

Another alternative method of episodic game-play is a “Comping Events” method. When playing a basic wagering game, the player acquires points, or “comps,” that can be used toward a bonus game. Then, when the bonus game is triggered the player can select from a variety of bonus games to play, based on how many “comp” points they have acquired. For example, four different bonus events are displayed upon triggering a bonus game. Bonus A requires four points to play, Bonus B requires eight points to play, Bonus C requires twelve points to play, and Bonus D requires sixteen points to play. A player that has acquired twelve points can select any one of Bonus A, Bonus B, and Bonus C.

Another alternative method of episodic game-play is a “Level Status” method. When playing a wagering game, a player acquires points to achieve a point threshold that raises the status of the player. For example, a player may begin play on a gaming terminal at a “gold” level. During the course of game-play of the wagering game, if the player acquires enough points, the player's status may be raised to a “platinum” level. New reel symbols or wagering mechanics can be made available to the player when a new status level is reached.

While the invention is susceptible to various modifications and alternative forms, specific embodiments thereof have been shown by way of example in the drawings and herein described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

1. A method for conducting a wagering game, comprising:
receiving a wager input from a player for playing a wagering game during a gaming session, said wagering game having a game-play progression that includes a plurality of game episodes;
selecting at least one randomly-selected outcome of a plurality of outcomes in response to said receiving step;
in response to a predetermined game-play condition, completing a first game episode of said plurality of game episodes;
saving a status of said game-play progression after said completing step; and
in response to playing a subsequent gaming session of said wagering game, continuing game-play from said status of said game-play progression in a second game episode of said plurality of game episodes.

2. (canceled)

3. The method of claim 1, further comprising displaying said first game episode on a first gaming terminal and said second game episode on a second gaming terminal.

4. (canceled)

5. The method of claim 1, further comprising displaying a plurality of gaming themes of at least one of said plurality of game episode, said plurality of gaming themes including a first theme being displayed on a first gaming terminal and a second theme being displayed on a second gaming terminal, said plurality of gaming themes having at least one of a visual and an audio indicia.

6. The method of claim 1, further comprising selecting said predetermined game-play condition from at least one of choosing a game path, unlocking an event, accumulating a predetermined number of points, achieving a predetermined status level, and completing a percentage of said game-play progression.

7. The method of claim 1, wherein said second game episode is a bonus round of said wagering game.

8. (canceled)

9. The method of claim 1, wherein said continuing step includes accessing information related to said status during said subsequent gaming session.

10. The method of claim 1, further comprising storing information related to said status of said game-play progression on a player-tracking device before terminating said gaming session.

11-19. (canceled)

20. A gaming terminal for playing a wagering game, comprising:
a display for displaying at least one randomly-selected outcome of a plurality of outcomes in response to accepting a wager from a player for playing a wagering game, said wagering game having a game-play progression that includes a plurality of game episodes; and
a controller coupled to said display and operative to save a status of said game-play progression when a first game episode of said plurality of game episodes has been completed, said first game episode being completed in response to an occurrence of a predetermined game-play condition during a gaming session of said wagering game; and
continue game-play from said status of said game-play progression in a second game episode of said plurality of game episodes, said second game episode occurring in a subsequent gaming session of said wagering game.

21. The gaming terminal of claim 20, wherein said plurality of game episodes is related to at least one of a player adventure, a character adventure, an unlocked event, a storyline, and a path progression.

22. The gaming terminal of claim 20, further comprising a memory device for saving said status of said game-play progression.

23. The gaming terminal of claim 20, further comprising a player-tracking device for activating said second game episode.

24. The gaming terminal of claim 20, wherein said controller is further programmed to determine when said first game episode has been completed in response to at least one of completing a percentage of game-play of said wagering game, completing a predetermined episode of said plurality of episodes, unlocking an event, accumulating a predetermined number of points, achieving a player status, and selecting a game-play option.

25. The gaming terminal of claim 20, further comprising gaming indicia on said display, said gaming indicia including at least one of a visual element and an audio element, said controller being further programmed to change said gaming indicia when continuing said game-play in said second game episode.

26. The gaming terminal of claim 20, further comprising a player-tracking device for accessing information in a player-tracking card, said information being related to said game-play progression.

27. The gaming terminal of claim 20, wherein said controller is further programmed to change a game theme associated with said first game episode when said game-play is continued in said second game episode.

28. A method for conducting multiple wagering games, comprising:
receiving a first wager input for playing a first wagering game during a gaming session, said first wagering game having a first game episode;
selecting at least one randomly-selected outcome of a plurality of outcomes in response to receiving said first wager input;
in response to completing said first game episode, saving a status of a game-play progression;
receiving a second wager input for playing a second wagering game during a subsequent gaming session, said second wagering game having a second game episode; and
continuing game-play from said status of said game-play progression in said second game episode.

29. The method of claim 28, further comprising displaying said gaming session on a first gaming terminal and said subsequent gaming session on a second gaming terminal.

30. The method of claim 28, further comprising displaying at least one of a first gaming theme of said first game episode and a second gaming theme of said second game episode on at least one of a first gaming terminal and a second gaming terminal.

31. The method of claim 28, wherein said saving step includes storing said status on a memory device associated with a first gaming terminal.

32. (canceled)

33. The method of claim 31, further comprising accessing said memory device for information related to said status on a second gaming terminal.
